(19) United States
(12) Patent Application Publication
(10) Pub. No.: US 2014/0182135 A1
(43) Pub. Date: Jul. 3, 2014

(54) Dry Shaver with Pivotal Shaving Head

(71) Applicant: Braun GmbH, Kronberg (DE)

(72) Inventors: Diana Kappes, Hofheim (DE); Joerg Kaiser, Emmendingen (DE); Alexander Kloes, Kriftel (DE); Bernhard Kraus, Braunfels (DE); Andreas Larscheid, Bad Soden (DE); Stefan Rehbein, Bad Soden (DE)

(73) Assignee: Braun GmbH, Kronberg (DE)

(21) Appl. No.: 14/200,107

(22) Filed: Mar. 7, 2014

Related U.S. Application Data
(62) Division of application No. 12/206,041, filed on Sep. 8, 2008.

(51) Int. Cl. B26B 19/14

(52) U.S. Cl. CPC B26B 19/14
USPC 30/42

(57) ABSTRACT

A dry shaver with a housing featuring a drive motor and a shaving head connected to the housing for pivotal movement about a pivot axis. The shaving head mounts at least two shaving systems, each comprised of an outer cutter and associated under cutters. The under cutters are adapted to be driven in an oscillatory linear motion relative to the outer cutter. The at least two under cutters are mounted respectively on separate oscillatory elements in the shaving head. The oscillatory elements are each connected to the drive motor via drive elements and are driven in mutually opposite directions.

### FIELD OF THE INVENTION

This invention relates to a dry shaver.

### BACKGROUND OF THE INVENTION

A dry shaver is known in the art from DE 36 10 736 C2. The dry shaving apparatus disclosed therein is characterized already by very good adaptability to the contour of skin to be shaved and as such produces excellent shaving results. The known shaver has a drive pin projecting out of the housing and driven in an oscillating movement, which drive pin drives a drive plate arranged on the pivotal shaving head, there being arranged on the drive plate two under cutters which then reciprocate jointly and in the same direction when the drive motor is activated. Without suitable counter-measures, the under cutters oscillating in the same direction would generate disturbing vibrations for the user. Suitable vibration reduction measures, for example using balance weights oscillating in mutually opposite directions, are complex and also require additional space in the pivotal shaving head, whereby the weight of the shaving head is increased.

### SUMMARY OF THE INVENTION

In one aspect, a dry shaver includes a housing, a drive motor arranged in the housing, a driver coupled to the drive motor, and a shaving head. The shaving head is adapted to couple to the housing and is pivotable about an axis defined by the housing. The shaving head includes at least two shaving systems. Each shaving system includes an outer cutter, an oscillator adapted to couple to one of the drivers, and an under cutter coupled to the oscillator. The under cutter of a first one of the shaving systems it drivable in a mutually opposite direction from the under cutter of a second one of the shaving systems.

In some implementations, one drive element driven in a rotary movement is passé out through the housing. The drive element provides for the drive motor to have a rotationally driven drive shaft. The drive shaft has at least two eccentric portions or drivers arranged one behind the other in the axial direction. Also it is conducive to simple construction to arrange for the drive elements to engage directly in portions of the oscillatory elements. Depending on the requirements or restrictions with regard to the space available, it can be an advantage for the drive elements to be connected to the oscillatory elements by means of respective intermediate transmission means. Said transmission means can be constructed, for example, as a connecting rod or, alternatively, as a joint pushrod. A particularly simple constructional design for the transmission of drive energy into the shaving head is for each of the oscillatory elements to have a slotted portion for the direct or indirect coupling of the respective drive element, with the slot extending in a direction transverse to the pivot axis of the shaving head. Advantageously, in this arrangement at least one of the slots is constructed as a through0skit so that, in accordance with a particularly simple embodiment of the invention, the drive elements can be constructed as two eccentric elements arranged one behind the other.

Some implementations provide for two oscillatory elements to be mounted to fit within one another or to be coupled to one another, thereby obviating the need for additional bearing means.

Particularly great freedom of construction and design is possible with regard to the overall geometry and design of the shaving head. For example, a shaving head with two differently sized cutting systems is provided by an embodiment in which the oscillatory elements are driven with different or variously large amplitudes. If, for example, the under cutters of the respective shaving systems have variously large masses, this will result in unwanted vibrations. Said vibrations can balance each other by accordingly coordinated, variously large oscillation amplitudes.

As described herein, it is possible to greatly improve the vibration behavior of a dry shaver with pivotal shaving head or to compensate for vibrations already directly in the shaving head itself. For example, one embodiment provides for there to be at least two drive elements driven in a translational oscillating movement, with each drive element adapted to be coupled to one of several oscillatory elements. It is thus possible to greatly minimize the space required in the shaving head itself for the arrangement of oscillatory bridges, allowing for a compact design, including a shaving head with a small overall height.

Further objects, features, advantages and application possibilities will become apparent from the subsequent description of the embodiments. It will be understood that any single feature and any combination of single features described or represented by illustration form the subject matter of the present description, and do so independently of their summary in the claims.

### BRIEF DESCRIPTION OF THE DRAWINGS

FIG. 1 is an exploded perspective view of a dry shaver;

FIG. 2 is a sectional view of a dry shaver, taken parallel to the vertical axis and transverse to the pivot axis;

FIG. 3 is a perspective view of an oscillatory bridge arrangement;

FIG. 4 is a view of another embodiment;

FIGS. 5 to 8 are several representations of alternative embodiments; and

FIGS. 9 and 10 are views of another embodiment.

Mutually corresponding component and function parts are assigned like reference characters in the following.

### DETAILED DESCRIPTION OF THE INVENTION

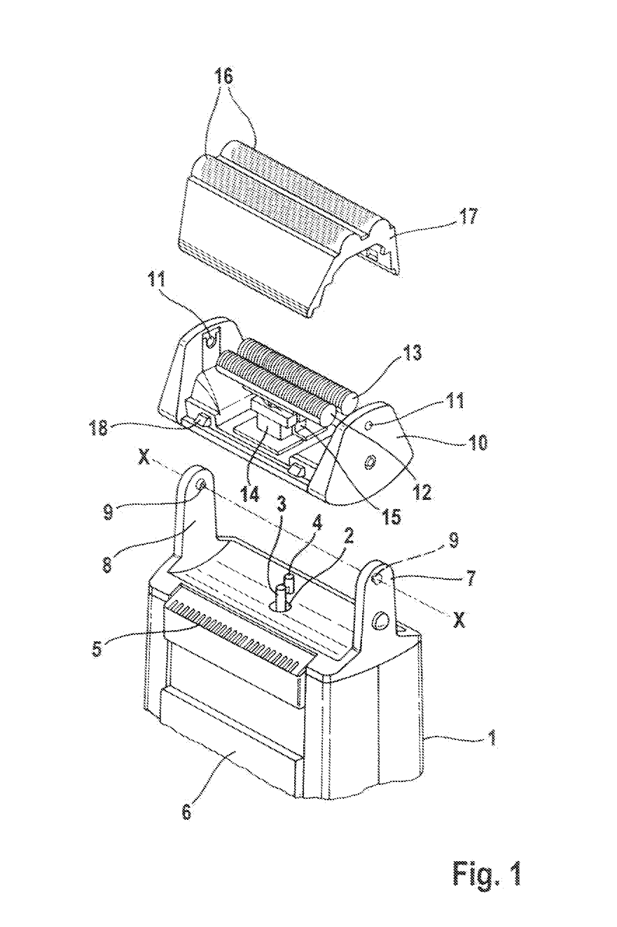

FIG. 1 shows a dry shaver with a housing (1) which in the region of its upper end has a cutout (2) through which a first and a second eccentric portion (3 and 4), respectively, of a drive shaft project. Said drive shaft is driven for rotary movement by an electric motor not shown in this representation.

Arranged on the front wide side of the housing is a trimmer (5) which can be displaced and switched on by means of a switch (6). The upper end also includes two arms (7 and 8) which are constructed as extensions of the narrow sides of the housing and have bearing points (9) for mounting the shaving head (10). For this purpose the shaving head (10) has corresponding bearings (11) which are arranged on its side cheeks. In the assembled state the shaving head (10) is mounted in the housing (1) such as to be pivotal about the axis X-X.

This pivoting capability ensures that the two cutting systems, which will be described later, of the shaving head (10) invariably engage the skin to be shaved at an optimal angle, and do so regardless of the angular position of the housing (1) relative to the skin.

The shaving head (10) mounts in its interior a first and a second under cutter (12 and 13) by means of associated oscillatory bridges, namely the first oscillatory bridge (14) and the second oscillatory bridge (15), for translational displacement in a direction parallel to the pivot axis X-X. Each under cutter (12, 13) includes a plurality of blades arranged one behind the other and in parallel alignment.

When the shaving head (10) is mounted on the housing (1) by means of the bearing points (9), the two eccentric portions (3 and 4) engage respectively in corresponding coupling portions of the associated oscillatory bridges (14 and 15), respectively. With the drive shaft rotating, the two under cutters (12, 13) are then moved in phase opposition to each other, performing a translational oscillatory movement. Assigned to each under cutter (12, 13) is a shaving foil (16) which is provided in an exchangeable frame (17). The latter has on its inner side corresponding recesses by means of which the exchangeable frame (127) can be securely coupled to the shaving head (10) in combination with catches (18) arranged on the shaving head (10).

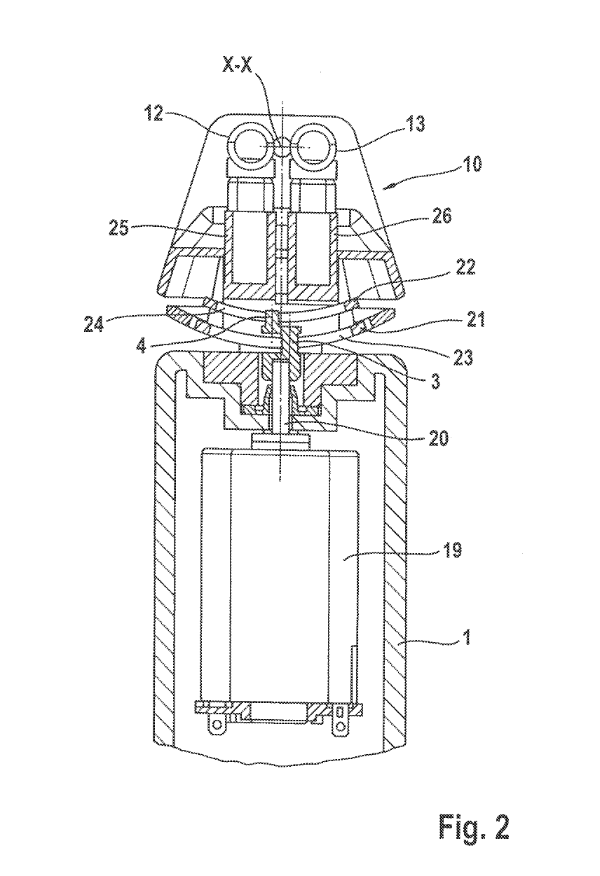

FIG. 2 shows a section perpendicular to the axis X-X, taken through the middle of a dry shaver. This representation shows the electric motor, which is arranged in the housing (1), and its drive shaft (20), which is driven in a rotary motion. The electric motor (19) is fixedly integrated in the housing (1) and can be actuated by an On/Off switch. Mounted on the drive shaft (20) in a non-rotating relationship and axially secured against displacement in a shaped part which has a first and a second eccentric portion (3 and 4), respectively. In this arrangement, said eccentric portions are arranged axially one behind the other and their eccentricities lie diametrically opposed, that is, they are turned through an angle of 180° relative to each other. The first eccentric portion (3) lies nearer to the electric motor (19), while the second eccentric portion lies close to the shaving head (10). The first eccentric portion (3) engaged in the coupling portion (21) which is integrally formed on the first oscillatory bridge (14) and thus connects the first under cutter (12) to the electric motor (19). Integrally formed on the second oscillatory bridge (15) is likewise a coupling portion (22) which connects with the second eccentric portion (4) and hence with the electric motor (19).

The eccentricities of the two eccentric portions (3 and 4) equal 1.5 mm, approximately, so that during the operation of the electric motor (19) the under cutters (12, 13) perform an oscillation in mutually opposite directions with an amplitude of 3 mm, approximately. Because the eccentric portions are arranged on the same drive shaft (20), the oscillations of the under cutters (12, 13) also have the same oscillation frequency. As long as the moved masses are equally large, oscillations will balance each other in full by the opposite directions of movement. It is also possible of course to construct a shaving head which has cutting systems of different size, which then leads to moved masses equally differing in size. To obtain full balance of the oscillation forces in this case, it is possible to adjust the drive system such that the eccentricities of the eccentric portions differ from each other. A smaller amplitude would then be imposed on the cutting system with the larger mass than on the lighter cutting system.

To receive the eccentric portion (3) the coupling portion (21) has a slot (23) extending in a direction transverse to the pivot axis X-X, while the coupling portion (22) has a similarly extending slot (24) in which the second eccentric portion (4) is received. The two coupling portions (21 and 22) are constructed to be arch-shaped in cross section and extend approximately concentrically to the pivot axis X-X. As the result, during the pivot movement about the axis X-X, the coupling portions are move solely on their respectively assigned radii. The relative axial distances of the eccentric portions (3, 4) can be selected very small therefore. Similarly, the coupling portions (21, 22) can also be constructed to lie close together. Consequently the eccentric portions (3, 4) also need to have only a small axial dimension because, contrary to a construction of the coupling portions with a rectilinear cross section, there occurs no tilting of the coupling elements relative to the drive shaft in dependence upon the angle of pivot about the axis X-X. The length of the slots (23 and 24) is coordinated with the maximum pivot angle of the shaving head (10). In vertical direction the slots (23 and 24) are constructed as through slots; at least the slot (23) must be constructed as a through hole to enable the second eccentric portion (3) to be passed through it. The slot (24) can also be constructed as a slot-shaped groove which does not extend throughout. Each of the two oscillatory bridges (14, 15) carries a mounting well (25 and 26), respectively, in which the under cutters (12 and 13), respectively, can be mounted in known manner by means of suitable axles or pins. Seated between the mounting wells (25, 26) and their associated under cutters (12 and 13), respectively, are spring elements which bias the under cutters in the direction of the shaving foils (16). Full surface contact between the under cutters and the associated shaving foils is thus assured at all times.

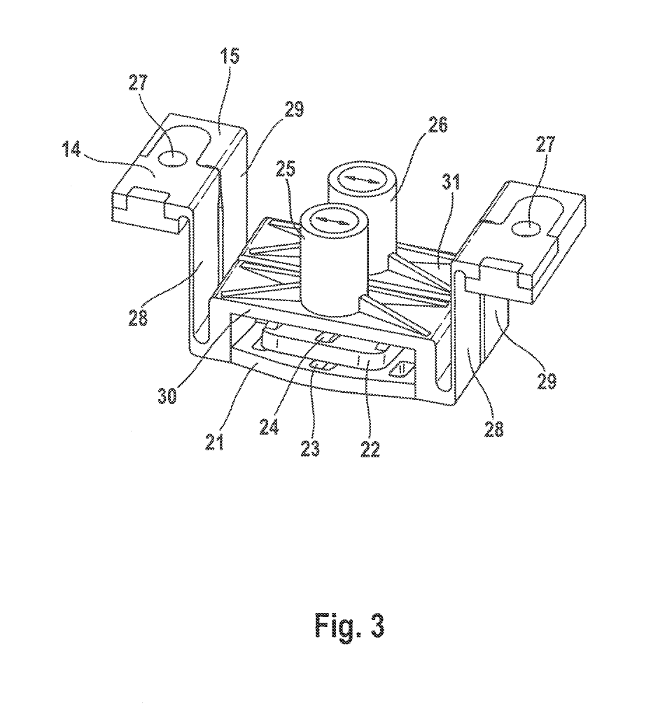

FIG. 3 shows an oscillatory bridge arrangement according to FIG. 2 with the first oscillatory bridge (14) and the second oscillatory bridge (15). This Figure shows clearly how the two coupling portions (21 and 22) are nested together and cover, at least perpendicular to the oscillation direction (double arrow), the region underneath both oscillatory bridges.

In the region of the fastening points (27) by means of which the oscillatory bridges are fastened in the shaving head (10), said bridges are dovetailed so that as the result of this positive engagement they can be fixed in the shaving head (10) with a single shared fastening screw. Extending vertically downwards from this fastening zone are a total of four leaf-shaped portions (28, 29), with the portions (28) of the first oscillatory bridge (14) lying on the left and right alongside the carrier (30) of said oscillatory bridge and connecting said carrier elastically to the fastening zone. The same applies to the second oscillatory bridge (15) and its leaf-shaped portions (29), which are associated with the carrier (31). To enable the coupling portion (22) to also perform oscillating movements in its mounting space, provision is made for adequate clearance between the portion and all the parts of the first oscillatory bridge (14).

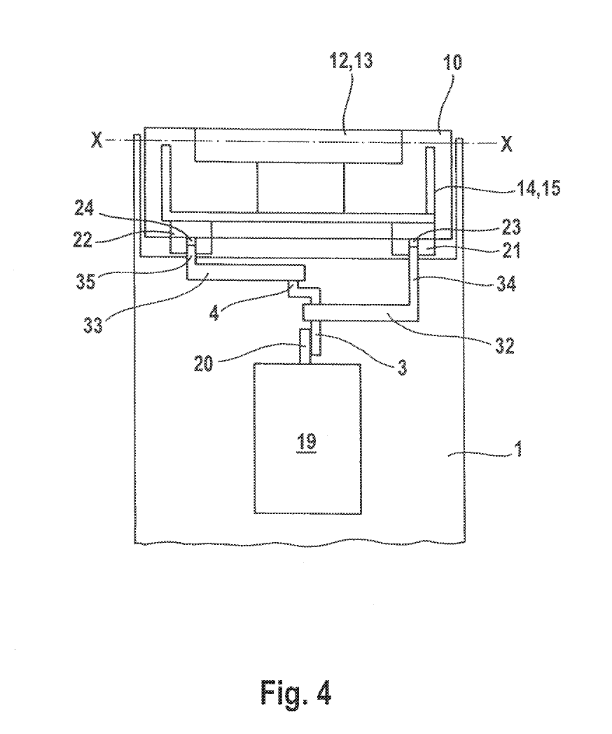

FIG. 4 shows an embodiment in which the coupling portions (21, 22) of the oscillatory bridges (14, 15) are not nested together but arranged side by side. In this example, too, an electric motor (19) with a drive shaft (20) is arranged in the housing (1) of the shaving apparatus, with the drive shaft (20) mounting two eccentric portions (3 and 4). Mounted on each of the eccentric portions (3, 4) is a connecting rod (32 and 33), respectively, whose pin (34 and 35), respectively, connects with associated coupling portions (21 and 22), respectively, of the oscillatory bridges (14 and 15), respectively. The pins (34 and 35) are mounted for displacement within groove-shaped slots (23 and 24), respectively, said slots (23 and 24) extending, as in the preceding Figures, in the associated coupling portions (21 and 22), respectively, in a direction transverse to the pivot axis X-X of the shaving head (10). The oscillatory bridges (14 and 15) lie one behind the other in the plane of projections, each carrying one of the under cutters (12 and 13), respectively. When the drive shaft (20) rotates, the linear oscillation parallel to the pivot axis X-x is transferred via the connecting rods (32, 33) to the oscillatory bridges. Because—as in the preceding example, the eccentric portions (3, 4) are turned relative to each other through an angle of 180°, the oscillatory bridges (14, 15) oscillate in mutually opposite directions. Due to the arrangement of the slots (23, 24) in a direction transverse to the pivot axis X-X and the displaceable mounting of the pins (34, 35) within said slots, the shaving head (10) can be pivoted while the driving connection between the electric motor (19) and the oscillatory bridges (14, 15) is maintained.

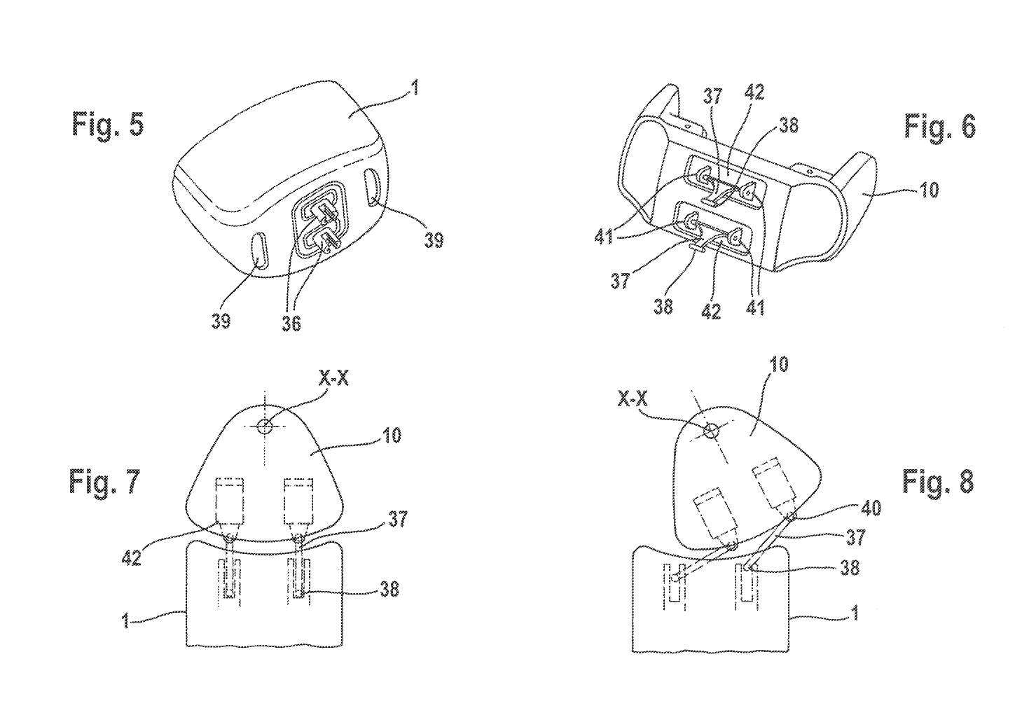

FIGS. 5 to 8 show an embodiment in which two drive elements performing oscillatory motions in mutually opposite directions project from the housing (1). The drive elements involved are two pin-shaped oscillators (36) extending in a sealed relationship out of the housing and having recesses for pivotally receiving the lower ends (38) of respective joint pushrods (37). In this arrangement, the mounting of the joint pushrods in the oscillators is pivotal as well as linearly displaceable.

In FIGS. 5 and 6, the housing of the dry shaver and the shaving head (10) are shown separated from each other, and the representation of a holding yoke for the pivotal mounting of the shaving head (10) is dispensed with. The yoke is passed out of the housing (1) through the openings (39) and includes bearing points which cooperate in a manner known in the art with corresponding bearing points of the shaving head.

FIG. 7 shows a side view in which the shaving head (10) is in a mid-position, while FIG. 8 shows the pivot position of the shaving head (1) as swung out relative to the housing (1).

Each of the two joint pushrods (37) has its upper end (40) pivotally connected via corresponding eyelets (41) to a respective oscillatory plate (42). This connection enables the joint pushrod (37) to be pivotal about an axis extending parallel to the pivot axis X-X. It lies moreover parallel to the oscillation direction of this oscillators and to the respective oscillatory plates (42) connected to them.

On account of this connection the oscillatory plates (42) are driven to perform oscillatory linear motions in mutually opposite directions. The plates contain arrangements, not shown in greater detail, for mounting the under cutters. The pivotability of the joint pushrods within their bearings and the linear displaceability of the lower end (38) within the oscillators (36) is coordinated such that this driving connection is able to follow the maximum pivotability of the shaving head (10) relative to the housing (1) about the pivot axis X-X.

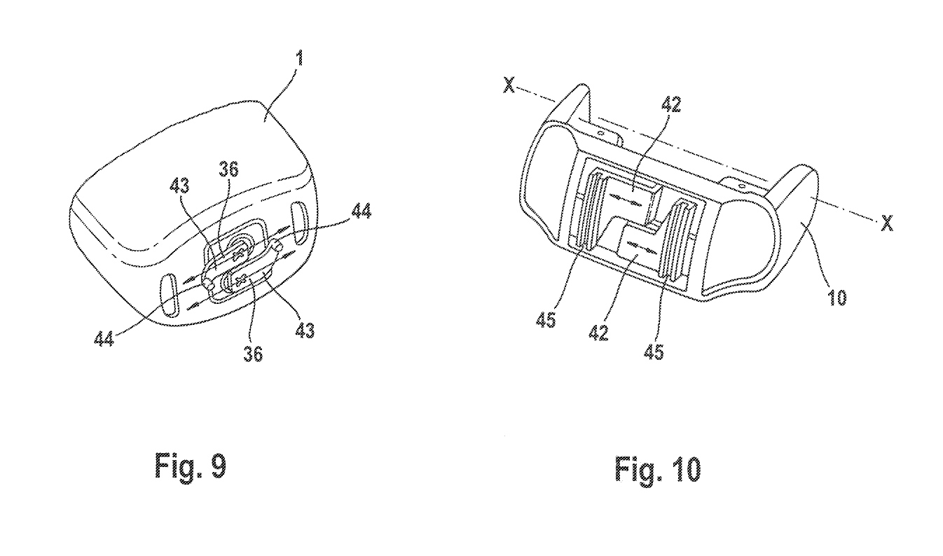

Another embodiment is shown in FIGS. 9 and 10 which, like the representation in FIGS. 5 and 6, show a housing (1) with a shaving head (10) detached therefrom. Projecting out of the housing (1) in this embodiment are two oscillators (36) which lie side by side adjacent to each other and are driven to perform oscillatory linear motions in mutually opposite directions. The oscillators (36) have plate-shaped portions (43) which carry pin elements (44) on an inwardly bent region. These pin elements (44) are arranged so far inside that they move on a common straight line during oscillating operation of the oscillators (36). As in the preceding embodiment the shaving head (10) is connected via a yoke element, not shown, to the housing (1) such as to be pivotal about the axis X-X. In the mounted state of the shaving head (10), the pin elements (44) engage within a respective associated transverse groove (45) which is formed on a respective oscillatory plate (42) and extends in a direction transverse to the pivot axis X-X. The two oscillatory plates (42) are mounted in the shaving head (10) for displacement parallel to the pivot axis X-x and lie parallel to each other. Each transverse groove (45) is arranged in a portion of its oscillatory plate (42) which overlaps the adjacent oscillatory plate at least in part. These portions are nested in each other like stair steps. The two oscillatory plates can be mounted for displacement within each other by means of suitable arrangements, for example, a tongue-and-groove connection or a dovetail connection. The double arrows in the FIGS. 9 and 10 indicate the direction of the oscillation movement of the components concerned, with the two oscillators (36) and hence also the oscillatory plates (42) carrying a respective under cutter being driven in mutually opposite directions.

What is claimed is:

1. A dry shaver comprising:
a housing (1);
an electric motor (19) arranged in the housing, said motor having a drive shaft (20), said drive shaft mounting two eccentric portions (3, 4), said eccentric portions being turned relative to each other through an angle of 180° and providing driving connection between the motor and oscillatory bridges (14, 15);
a shaving head (10) configured to be coupled to the housing and pivotable about a pivot axis (X-X) defined by the housing, the shaving head comprising at least two shaving systems, each shaving system comprising:
an outer cutter (16) with associated under cutters (12, 13);
an oscillatory bridge (14, 15), respectively, associated with each said undercutter, respectively, said bridges (14, 15) being arranged side by side, each of said eccentric portions (3, 4) comprising a connecting rod (32, 33), respectively, with pins (34, 35), respectively, connected with associated arch-shaped coupling portions (21, 22), respectively, of the oscillatory bridges (14, 15), respectively, said pins (34, 35) being mounted for displacement within groove-shaped slots (23, 24), respectively, said slots (23, 24) extending in the associated coupling portions (21, 22), respectively, in a direction transverse to the pivot axis (X-X) of the shaving head (10), said oscillatory bridges (14, 15) lying one behind the other in the plane of projection; whereby, when the drive shaft (20) rotates, a resulting linear oscillation parallel to the pivot axis (X-X) is transferred via the connecting rods (32, 33) to the oscillatory bridges, causing the oscillatory bridges (14, 15) to oscillate in mutually opposite directions; and further, due to the arrangement of the slots (23, 24) in a direction transverse to the pivot axis (X-X) and the displaceable mounting of the pins (34, 35) within said slots, the shaving head (10) can be pivoted while the driving connection between the electric motor (19) and the oscillatory bridges (14, 15) is maintained.

2. A dry shaver according to claim 1, wherein the shaving head is configured to be coupled to the housing by two arms (7,8) constructed as extensions of two narrow sides of the housing, said head being pivotable about the pivot axis X-X defined by the coupling of the head by said arms.
